(19) United States
(12) Patent Application Publication
(10) Pub. No.: US 2013/0003077 A1
(43) Pub. Date: Jan. 3, 2013

(54) TOMOGRAPHIC IMAGING APPARATUS AND CONTROL APPARATUS FOR TOMOGRAPHIC IMAGING APPARATUS

(75) Inventors: Nobuhito Suehira, Kawasaki-shi (JP); Yukio Sakagawa, Tokyo (JP); Hirofumi Yoshida, Yokohama-shi (JP)

(73) Assignee: CANON KABUSHIKI KAISHA, Tokyo (JP)

(21) Appl. No.: 13/634,227

(22) PCT Filed: Mar. 25, 2011
(86) PCT No.: PCT/JP2011/001772

§ 371 Date: Sep. 11, 2012

(30) Foreign Application Priority Data
Mar. 31, 2010 (JP) 2010-082809
Mar. 31, 2010 (JP) 2010-082812

(51) Int. Cl. G01B 9/02

(52) U.S. Cl. 356/479

(57) ABSTRACT

A tomographic imaging apparatus configured to acquire a tomographic image or a cross-sectional image of an object to be examined from signals of a plurality of interfering beams obtained by emitting a plurality of measuring beams to the object to be examined and causing return beams of the measuring beams to interfere with reference beams includes a sensor configured to detect the plurality of interfering beams to acquire signals of the plurality of interfering beams, an acquisition unit configured to acquire an optical characteristic in the tomographic imaging apparatus corresponding to each of the plurality of interfering beams, and a generation unit configured to generate a tomographic image or a cross-sectional image of the object to be examined based on the signals of the plurality of interfering beams and the optical characteristic.

### TECHNICAL FIELD

The present invention relates to a tomographic imaging apparatus and a control apparatus for the tomographic imaging apparatus.

### BACKGROUND ART

Currently, various types of ophthalmic apparatuses implementing an ophthalmic apparatus are used. For example, there are anterior segment imaging apparatuses, fundus cameras, and confocal laser scanning ophthalmoscope as optical apparatuses for observing an eye. Among these apparatuses, there is an optical tomographic imaging apparatus that captures a high-resolution tomographic image of an object to be examined by optical coherence tomography (OCT) using low-coherent light. Thus, the optical tomographic imaging apparatus is becoming an essential ophthalmic apparatus for outpatient specialty of retina. In the following descriptions, the apparatus using optical coherence tomography is described as an OCT apparatus.

The above-described OCT apparatus measures a cross section of an object to be examined by dividing a low-coherent light beam into a reference beam and a measuring beam, directing the measuring beam onto an object to be examined, and causing a return beam from the object to be examined to interfere with the reference beam. In other words, by scanning the object to be examined with the measuring beam, a two-dimensional or a three-dimensional tomographic image can be obtained. If the object to be examined is biological such as an eye, the image may be distorted due to the motion of the eye. Thus, there is a demand for measuring an image of an object to be examined at a high speed and with high sensitivity.

As a method for measuring an object at a high speed and with high sensitivity, Japanese Patent Application Laid-Open No. 2008-508068 discusses a method for simultaneously measuring a plurality of points of an object to be examined. According to this method, a plurality of light sources are generated by dividing a beam emitted from one light source by a slit. Then, each of the obtained beams is divided into a measuring beam and a reference beam by a beam splitter. The measuring beam is directed onto an object to be examined. Then, a return beam from the object to be examined and the reference beam are combined by the beam splitter. After then, the plurality of combined beams are incident on a grating and are detected by a two-dimensional sensor at the same time. Thus, the method discussed in Japanese Patent Application Laid-Open No. 2008-508068 realizes high-speed measurement of an object by using a plurality of measuring beams at the same time.

However, if one image is generated by putting together a plurality of tomographic images obtained by measuring a plurality of points at the same time, the connected portions become noticeable depending on the configurations of the optical system. In other words, if the components of the optical system used for the measurement of each of the points are completely equivalent, the connected portions will not be a problem. If the components are not equivalent, however, due to the difference in the depth direction of the tomographic images, difference in contrast or resolution may occur.

Further, in generating a two-dimensional intensity image (cross-sectional image in the direction vertical to the measuring beam) from three-dimensional data obtained from an OCT apparatus that simultaneously measures a plurality of points by using a plurality of measuring beams, depending on the configuration of the apparatus, the obtained two-dimensional intensity image may be a cross-sectional image whose difference between the regions is noticeable. For example, if one cross-sectional image is generated from a tomographic image obtained by simultaneously performing measurement of a plurality of points, depending on the configuration of the optical system, the connected portion may be noticeable. In other words, if the optical systems used for the measurement of the plurality of points are completely equivalent, problems do not occur. If the systems are not equivalent, however, contrast or resolution of images may be inconsistent in the depth direction of the tomographic image.

### SUMMARY OF INVENTION

The present invention is directed to making a difference between cross-sectional images caused by an optical system in a tomographic imaging apparatus used for acquiring cross-sectional images from signals of a plurality of combined beams obtained by using a plurality of measuring beams or a difference between regions in a cross-sectional image less noticeable.

According to an aspect of the present invention, a tomographic imaging apparatus configured to acquire a tomographic image or a cross-sectional image of an object to be examined from signals of a plurality of interfering beams obtained by emitting a plurality of measuring beams to the object to be examined and causing return beams of the measuring beams to interfere with reference beams includes a sensor configured to detect the plurality of interfering beams to acquire signals of the plurality of interfering beams, acquisition means configured to acquire an optical characteristic in the tomographic imaging apparatus corresponding to each of the plurality of interfering beams, and generation means configured to generate a tomographic image or a cross-sectional image of the object to be examined based on the signals of the plurality of interfering beams and the optical characteristic.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an optical tomographic imaging apparatus according to a first exemplary embodiment of the present invention.

FIG. 2 illustrates a configuration of a spectrometer according to the first exemplary embodiment.

FIG. 3 illustrates an example of roll-off.

FIG. 4 illustrates a signal processing process according to the first exemplary embodiment.

FIG. 5A illustrates a fundus according to the first exemplary embodiment.

FIG. 5B illustrates a line A-A′ cross section according to the first exemplary embodiment.

FIG. 5C illustrates a line B-B′ cross section according to the first exemplary embodiment.

FIG. 6 illustrates a configuration of an optical tomographic imaging apparatus according to a second exemplary embodiment of the present invention.

FIG. 7 illustrates depth resolution after dispersion compensation.

FIG. 8 illustrates a signal processing process according to a third exemplary embodiment of the present invention.

FIG. 9A illustrates a two-dimensional intensity image of a schematic eye according to the third exemplary embodiment.

FIG. 9B illustrates a tomographic image of regions of the schematic eye according to the third exemplary embodiment.

FIG. 10 illustrates a signal processing process according to a fourth exemplary embodiment of the present invention.

FIG. 11 illustrates a three-dimensional arrangement of a tomographic image according to the fourth exemplary embodiment.

FIG. 12A illustrates a signal processing process according to a fifth exemplary embodiment of the present invention.

FIG. 12B illustrates a wavelength filter according to the fifth exemplary embodiment.

FIG. 13A illustrates a two-dimensional intensity image captured without using a filter according to the fifth exemplary embodiment.

FIG. 13B illustrates a two-dimensional intensity image captured using a depth filter according to the fifth exemplary embodiment.

FIG. 13C illustrates a two-dimensional intensity image captured using a wavelength filter according to the fifth exemplary embodiment.

### DESCRIPTION OF EMBODIMENTS

Various exemplary embodiments, features, and aspects of the invention will be described in detail below with reference to the drawings.

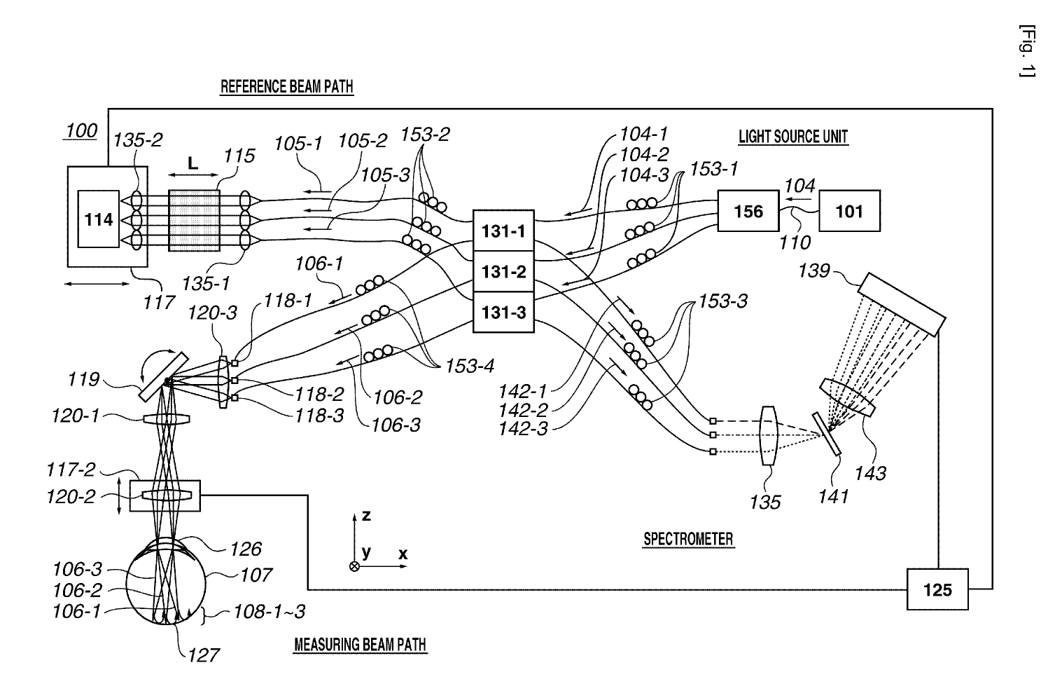

FIG. 1 illustrates a configuration of an optical tomographic image apparatus according to a first exemplary embodiment of the present invention. As illustrated in FIG. 1, an OCT apparatus 100 constitutes a Michelson interferometer as a whole. According to the present embodiment, a difference in a connected portion of images generated by the difference in characteristics of the configurations of the spectrometer is less noticeable. Processing of each function of the present embodiment and other exemplary embodiments can be performed by a computer reading a computer-executable program from a recording medium and executing it.

First, configurations of a tomographic imaging apparatus and a control apparatus for the tomographic imaging apparatus according to the present embodiment will be described with reference to FIG. 1.

An exiting beam 104 emitted from a light source 101 is incident on an optical coupler 156 after being guided by a single mode fiber 110, and is split into exiting beams 104-1 to 104-3 by the optical coupler 156. The exiting beams 104-1 to 104-3 pass through a first optical path, a second optical path, and a third optical path, respectively.

Further, the three exiting beams 104-1 to 104-3 pass through a polarization controller 153-1 and are split into reference beams 105-1 to 105-3 and measuring beams 106-1 to 106-3 by optical couplers 131-1 to 131-3, respectively. The three measuring beams 106-1 to 106-3 are reflected from or scattered by each measurement point of a retina 127 of a subject's eye 107 being the object to be observed and are then returned as return beams 108-1 to 108-3.

Then, the return beams 108-1 to 108-3 and the reference beams 105-1 to 105-3 that have travelled via a reference beam path are optically multiplexed by the optical couplers 131-1 to 131-3 to become combined beams 142-1 to 142-3. The combined beams 142-1 to 142-3 are divided according to the wavelength by a transmission diffraction grating 141 and are incident on a line sensor 139. The line sensor 139 converts the light intensity of each wavelength into a voltage for each sensor element. Then, by using the obtained signal, a tomographic image of the subject's eye 107 is obtained.

Next, the configuration of the light source 101 will be described. The light source 101 is a super luminescent diode (SLD) being a typical low-coherent light source. Since the light beam is used for measuring a subject's eye, near-infrared light is suitable. Further, the wavelength of the light is desirably short as the wavelength affects the resolution of the obtained tomographic image in the horizontal direction. Here, a light beam whose center wavelength is 840 nm and whose wavelength width is 50 nm is used. Different wavelength can be selected depending on the measurement portion to be observed. Further, although an SLD is selected as the light source in the description below, a different light source can be used so long as the light source can emit low-coherent light. Thus, light produced by amplified spontaneous emission (ASE) can also be used.

Next, the reference beam path of the reference beam 105 will be described. The three reference beams 105-1 to 105-3 split by the optical couplers 131-1 to 131-3 pass through a polarization controller 153-2 and become approximately parallel beams via a lens 135-1. Then, the reference beams 105-1 to 105-3 pass through a dispersion compensation glass 115 and are condensed onto a minor 114 by a lens 135-2. After then, the direction of the reference beams 105-1 to 105-3 is changed by the minor 114 and the reference beams 105-1 to 105-3 are directed again onto the optical couplers 131-1 to 131-3. After then, the reference beams 105-1 to 105-3 pass through the optical couplers 131-1 to 131-3 and are guided to the line sensor 139. The dispersion compensation glass 115 is used for compensating the dispersion that occurs when the measuring beam 106 travels to the subject's eye 107 and returns via the scanning optical system with respect to the reference beam 105.

In the following descriptions, for example, an average diameter of an oculus of a Japanese being L=23 mm is used. Further, a motorized stage 117 is provided. The motorized stage 117 moves in the directions indicated by the arrows. The motorized stage 117 is used for adjusting/controlling the length of the optical path of the reference beam 105. Further, the motorized stage 117 is controlled by a computer 125. Although the same components being the mirror 114, the motorized stage 117, and the dispersion compensation glass 115 are used for each of the three optical paths according to the present embodiment, different components can also be used.

Next, the measuring beam path of the measuring beam 106 will be described. Each of the measuring beams 106-1 to 106-3, which is split by the optical couplers 131-1 to 131-3, passes through a polarization controller 153-4 and is incident on a lens 120-3. Each of the measuring beams 106-1 to 106-3 exits the lens 120-3 as a parallel beam and is incident on a mirror of an XY scanner 119 included in the scan optical system. Although the XY scanner 119 is described as one minor to simplify the description, the XY scanner actually includes two mirrors being an X scan minor and a Y scan minor arranged close to each other. The XY scanner 119 performs raster scanning of the retina 127 in a vertical direction with respect to the optical axis.

A lens 120-1 and the lens 120-3 are adjusted so that the center of each of the measuring beams 106-1 to 106-3 substantially matches the center of rotation of the minor of the XY scanner 119. The lenses 120-1 and 120-2 are optical systems that cause the measuring beams 106-1 to 106-3 to scan the retina 127. Having a point near a cornea 126 as a support point, the measuring beam 106 scans the retina 127. Each of the measuring beams 106-1 to 106-3 forms an image on an arbitrary position on the retina.

A motorized stage 117-2 moves in the directions indicated by the arrows and is used for adjusting/controlling the position of the lens 120-2. By adjusting the position of the lens 120-2, the operator can concentrate each of the measuring beams 106-1 to 106-3 on a desired layer of the retina 127 of the subject's eye 107 and observe it. When the measuring beams 106-1 to 106-3 are incident on the subject's eye 107, the beams are reflected from the retina 127 or scattered. Then, return beams 108-1 to 108-3 pass through the optical couplers 131-1 to 131-3 and are guided to the line sensor 139. The motorized stage 117-2 is controlled by the computer 125. According to the above-described configuration, three measuring beams can be simultaneously scanned.

Next, a configuration of the detection system will be described. The return beams 108-1 to 108-3 reflected from the retina 127 or scattered and the reference beams 105-1 to 105-3 are optically multiplexed by the optical couplers 131-1 to 131-3. Then, the combined beams 142-1 to 142-3 which are optically multiplexed are incident on a spectrometer. As a result, a spectrum is obtained. By the computer 125 performing signal processing of the spectrum, a tomographic image is obtained.

Next, the spectrometer will be described. According to the configuration of the spectrometer of the present embodiment, a plurality of combined beams are processed by one line sensor. Thus, a low cost spectrometer is realized compared to a spectrometer including a two-dimensional sensor.

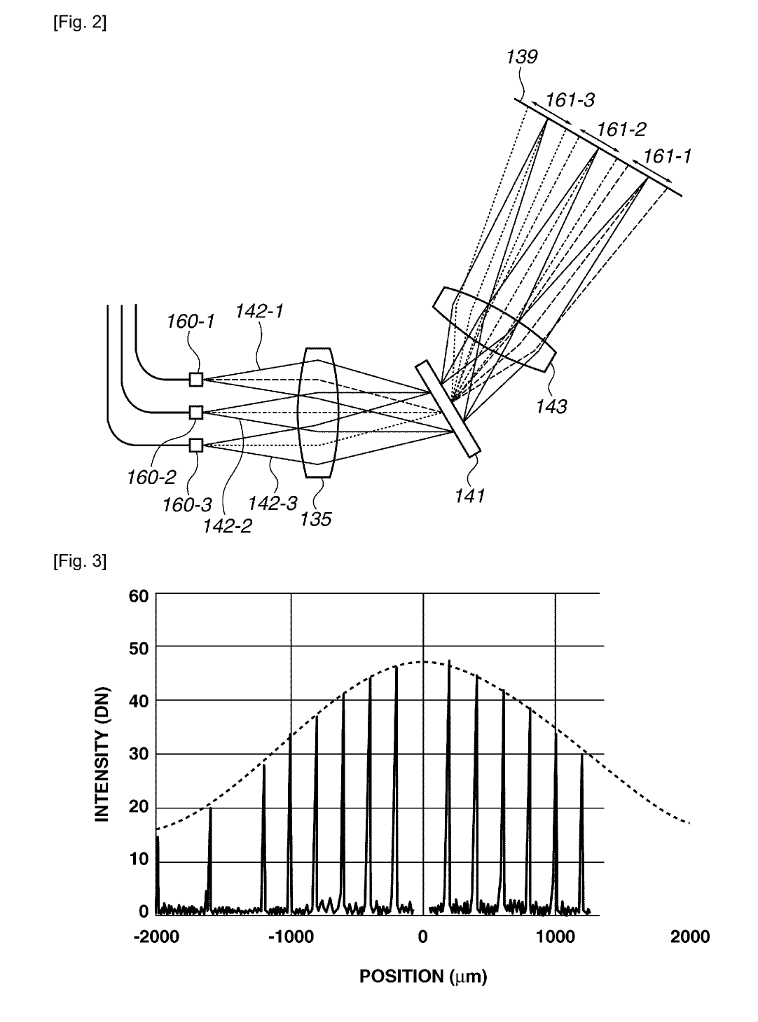

FIG. 2 illustrates a detailed configuration of the spectrometer illustrated in FIG. 1. In FIG. 2, three combined beams (142-1 to 142-3) are incident on the spectrometer. Fiber ends 160-1 to 160-3 are arranged with an interval between. The combined beams 142-1 to 142-3 are incident on the fiber ends 160-1 to 160-3, respectively. The directions of the fiber ends 160-1 to 160-3 are adjusted in advance so that the combined beams are vertically, in other words, telecentrically incident on the principal surface of the lens 135.

The combined beams are incident on the lens 135. The combined beams 142-1 to 142-3 become approximately parallel by the lens 135, and the three combined beams 142-1 to 142-3 are incident on the transmission diffraction grating 141. In order to reduce the loss of light quantity, it is necessary to arrange the position of the transmission diffraction grating 141 in the vicinity of the pupil of the optical system and provide a diaphragm on the surface of the transmission diffraction grating 141. Further, since the transmission diffraction grating 141 is arranged at an angle with respect to the principal surface of the lens 135, the light flux will be ellipsoidal on the surface of the transmission diffraction grating 141. Thus, the diaphragm on the surface of the transmission diffraction grating 141 needs to be ellipsoidal.

Each of the combined beams 142-1 to 142-3, which have been diffracted by the transmission diffraction grating 141, is incident on a lens 143. Regarding the diffracted combined beams illustrated in FIG. 2, only the light flux of the center wavelength is illustrated and only principal rays of the diffracted combined beams of other wavelengths are illustrated so as to simplify the illustration. Image formation is performed on the line sensor 139 by each of the combined beams 142-1 to 142-3 which have been diffracted and incident on the lens 143, and a spectrum is observed at positions indicated by arrows 161-1 to 161-3.

Table 1 summarizes the upper and the lower limits of the wavelength and the center wavelength being 840 nm of the measuring beam used in the present embodiment. As can be seen from the table, the diffraction angle is changed depending on the incident angle. As a result, the position of image formation is changed depending on the combined beam. Further, when a sensor element for 12 micrometers per pixel is used for the detection, the number of pixels is changed according to each combined beam. In other words, depending on the configurations of the optical system in the tomographic imaging apparatus, distribution characteristics of each combined beam on the line sensor 139 are changed.

TABLE 1
Relationship between combined beam and position of image
formation on line sensor in first exemplary embodiment

| | Incident | | Diffraction | Position | Number |
|---|---|---|---|---|---|
| Combined | angle | Wavelength | angle | of image | of |
| beam | (degrees) | λ | (degrees) | formation | pixels |
| 142-1 | 37.11 | 815.00 | 22.00 | −21.78 | 833 |
| | | 840.00 | 23.87 | −16.81 | |
| | | 865.00 | 25.77 | −11.80 | |
| 142-2 | 30.26 | 815.00 | 28.29 | −5.16 | 870 |
| | | 840.00 | 30.26 | 0.00 | |
| | | 865.00 | 32.28 | 5.27 | |
| 142-3 | 23.42 | 815.00 | 35.49 | 13.71 | 964 |
| | | 840.00 | 37.63 | 19.38 | |
| | | 865.00 | 39.83 | 25.27 | |

Next, the reason why an OCT signal is distorted on the line sensor will be described by a simple model by using a spectrum obtained by a spectrometer. Although the spectrometer is designed so that data is obtained at regular intervals with respect to the wavelength, since the data is converted into regular intervals with respect to wavelength by signal processing, it is assumed that an equal interval is realized with respect to the wave number in the following description. First, a spectrum after wavelength division is expressed as s(k) according to the wave number k. Since the size of the line sensor of the spectrometer is finite, if the window function is expressed as g(k), the spectrum obtained by the spectrometer will be obtained by the following equation (1).

[Math.1]

\tilde{s}(k)=∫s(k)−g(k−κ)dκ (1)

The OCT can be obtained by Fourier transform of a wave number spectrum. Thus, since equation (1) is a convolution, the OCT is equal to multiplication of functions after the Fourier transform as expressed in the following equation (2).

[Math.2]

FFT(\tilde{s}(k))=FFT(s)·FFT(g)=S(z)·G(z) (2)

If the window function g(k) is a square wave having a width of W and a height of 1, the Fourier transform thereof is expressed as the following equation (3).

$$\begin{matrix}[ Math . 3 ] & \\ G ( z ) = W \frac{sin ( zW / 2 )}{zW / 2} & ( 3 )\end{matrix}$$

In other words, where an ideal OCT image is FFT(s), since a sine function such as the one in equation (3) is multiplied, the intensity is attenuated from the point of origin to the first node. This is generally called as roll-off (attenuation characteristics). Further, the roll-off varies dependent on the width W. In other words, since the width W corresponds to the resolution (wave number) of the spectrometer, if the resolution is good, the slope of the roll-off will be gradual. If the resolution is not good, the slope of the roll-off will be steep.

FIG. 3 illustrates an example of the roll-off. The horizontal axis represents distance and the vertical axis represents intensity (digital value/12-bit sensor). The optical system used in this measurement is equivalent to two optical paths based on the reference beam paths illustrated in FIG. 1 having no dispersion compensation glass 115 and no scanner.

The position of the mirror in the measuring beam path is changed discretely between −2000 to 2000 micrometers with respect to the coherence gate. The coherence function is measured at each position and the obtained data is plotted. The coherence gate is a position where the optical path length of the reference beam path is equal to the optical path length of the measuring beam path. Further, since the area in the vicinity of the point of origin is related to the autocorrelation function of the light source, data of the vicinity of the point of origin is excluded. The dotted line represents an envelope obtained by plotting each peak of the coherence functions. The dotted line indicates that the intensity decreases as the distance from the coherence gate increases and that the roll-off has occurred.

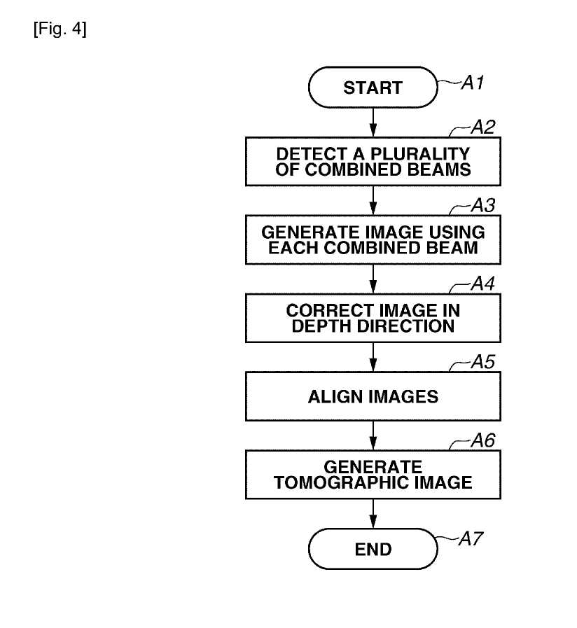

FIG. 4 illustrates the steps of signal processing of the first exemplary embodiment.

In step A1, the measurement is started. Before the measurement is started, the OCT apparatus is started and the subject's eye is set at position. Further, adjustment necessary in the measurement is performed by the operator.

In step A2, signals obtained by performing scanning with three measuring beams 106-1 to 106-3 via the XY scanner 119 are detected by the line sensor 139. The detected data is acquired by the computer 125, which functions as first acquisition means.

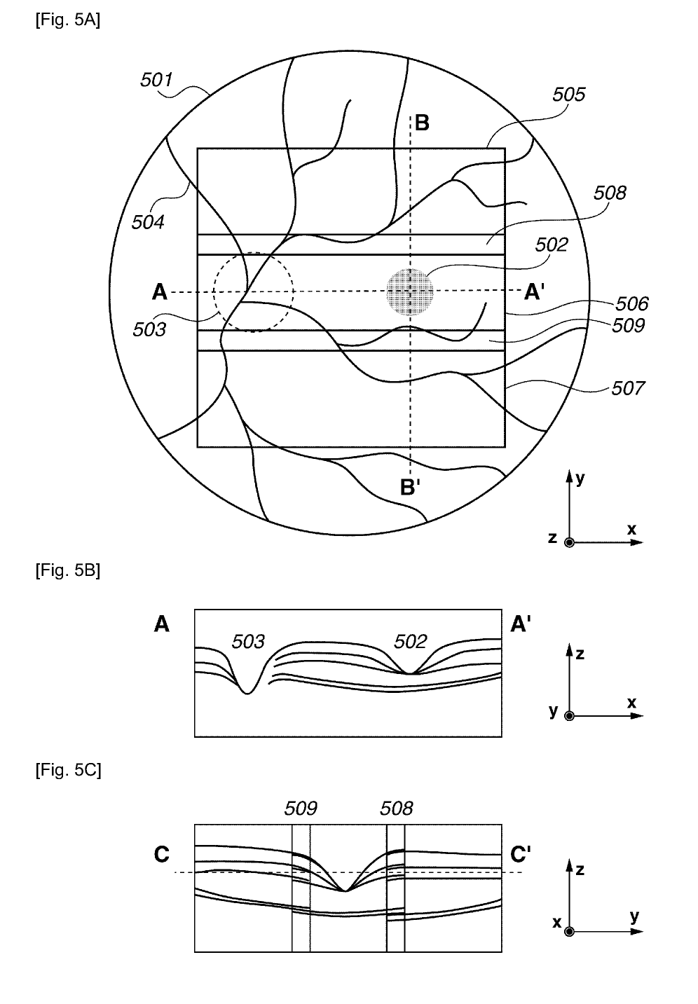

FIG. 5A is a schematic diagram of a fundus 501 and the scanning range of the measuring beams. The fundus 501 includes a macula lutea 502, an optic papilla 503, and a blood vessel 504. The three measuring beams scan a first scanning range 505, a second scanning range 506, and a third scanning range 507, respectively. Each region has an overlapping portion with the neighboring region. The first scanning range 505 and the second scanning range 506 have an overlapping region 508. The second scanning range 506 and the third scanning range 507 have an overlapping region 509. The area of the overlapping portion is approximately 20% of the scanning range.

Coordinate axes are set as illustrated. The x direction is the fast-scan direction. The y direction is the slow-scan direction. The z direction is the direction from the back side of the sheet to the front side. In the following description, 512 lines are scanned in the x direction for one measuring beam and 200 lines are scanned in the y direction. Further, excluding the overlapping portions, 512 lines are scanned by the three measuring beams in the y direction.

The combined beams 142-1 to 142-3, which are derived from the three measuring beams, are incident on the line sensor 139. Then, one-dimensional data of 4096 pixels is acquired. The data of 512 successive lines in the x direction is stored in units of data in two-dimensional arrangement (4096×512, 12 bits). When the scanning ends, 200 pieces of the data will be stored for one measuring beam.

In step A3, the computer 125 generates a tomographic image corresponding to each measuring beam using the data acquired from the line sensor 139. The tomographic image to be generated is a tomographic image of a cross section parallel to the direction of the emission of the measuring beam. The computer 125 functions also as second acquisition means configured to acquire data of distribution characteristics of each combined beam on the line sensor 139 for correcting the tomographic image.

Next, physical resolution of a tomographic image as a difference of the fundus in the depth direction due to the configuration of the optical system will be described. The resolution is generally determined by the bandwidth of the light source. Regarding spectral-domain (SD)-OCT, if the maximum pixel and the minimum pixel used in the signal processing match the greatest wave number and the smallest wave number of the light source, then the resolution is expressed by the following equation (4).

$$\begin{matrix}[ Math . 4 ] & \\ δ L = \frac{1}{2 Δ K} & ( 4 )\end{matrix}$$

Thus, if the wavelength is 815 nm-865 nm, the resolution will be 7 micrometers in air. Further, this value matches the distance of one pixel. For example, if the distance of one pixel is 7 micrometers, then the position of 1000 micrometers in FIG. 3 will be 142 pixels. However, if the number of pixels is changed depending on the combined beam as illustrated in table 1, the image size will be different with the three measuring beams, which will cause inconvenience. Thus, the number of pixels is increased so that images of the same size are obtained. It is convenient to generate data of 2 to the n-th power by adding a pixel of zero (zero padding) so that high speed Fourier transform can be performed.

On the other hand, this means that the bandwidth has numerically increased and that the equivalent distance per pixel is reduced. For example, regarding the combined beam 142-2, the effective number of pixels is 870, and 154 zeros are added. If the zeros are equally added before and after, it is regarded as a band of roughly 810 nm-869 nm. Thus, the equivalent distance per pixel (converted into physical distance corresponding to one pixel) will be 6 micrometers. Naturally, if the distance of the pixel used in the calculation is smaller than the band of the light source, the equivalent distance per pixel will be inferior to physical resolution.

The generation of a tomographic image is performed after matching the number of pixels per line (1024 in this case). The generation of a tomographic image is performed according to common generation processing of OCT images such as stationary noise elimination, wavelength wave number conversion, and Fourier transform.

Next, FIG. 5B is a B-scan image of a cross section taken along line A-A′. Since the B-scan image illustrated in FIG. 5B is obtained by using a single measuring beam, the image is natural. On the other hand, FIG. 5C is a B-scan image of a cross section taken along line B-B′. Since the B-scan image illustrated in FIG. 5C is obtained by using different combined beams, due to difference in resolution per one pixel, discontinuation of the cross section occurs. This gives a significant impact on a C-scan image taken along line C-C′ since a structure such as a blood vessel disappears or appears at the interface. Further, in addition to the difference due to resolution, difference due to contrast caused by difference in the roll-off also occurs.

In step A3, a tomographic image of Db(p,q,r) corresponding to each combined beam is obtained. “p” indicates the z direction. Although the number of pixels per line is 1024, only pixels 0 to 511 are extracted since pixels are symmetrical according to the Fourier transform. “q” indicates the x direction (pixels 0-511). “r” indicates the y direction (pixels 0-199). Further, “b” indicates a number (1-3) of the combined beam.

As a data expansion method, the spectrum data can be interpolated in advance so that a spectrum of 1024 pixels is presented and then the Fourier transform is performed. Further, the number of pixels per line can be set to the number of pixels in table 1, and then the interpolation can be performed after generation of each tomographic image.

In step A4, correction in the depth direction is performed. First, resampling in the z direction is performed. This is to match the equivalent distance per pixel between the three measuring beams. Here, the reference distance of one pixel is the equivalent distance of the second measuring beam (measuring beam at the center of the measurement regions). If straight line interpolation is performed, it is expressed by the following equation (5) by using the greatest integer function where the equivalent distance per pixel of each measuring beam is Lb. [x] is the greatest integer that does not exceed “x”. Further, since it is similar with q and r, only p in the z direction is used.

$$\begin{matrix} [ Math . 5 ] & \\ {H}_{b} ( p ) = ( 1 - \frac{{pL}_{b}}{{L}_{2}} + [ \frac{{pL}_{b}}{{L}_{2}} ] ) {D}_{b} ( [ \frac{{pL}_{b}}{{L}_{2}} ] ) + ( \frac{{pL}_{b}}{{L}_{2}} - [ \frac{{pL}_{b}}{{L}_{2}} ] ) {D}_{b} ( [ \frac{{pL}_{b}}{{L}_{2}} ] + 1 ) & ( 5 )\end{matrix}$$

As a result of the interpolation, although the number of elements with respect to each measuring beam is different, the number is adjusted to the smallest element number. Further, it can be furthermore reduced. Especially, if the object to be examined is an eye, since the equivalent distance per pixel is 6 micrometers, 400 pixels corresponds to 2.4 mm. Thus, it is enough for measuring the retina. Here, i is 0-399.

Next, normalization of the contrast in the depth direction in the z direction is performed. The roll-off characteristics of all the measuring beams are measured or obtained by simulation in advance.

Where roll-off characteristics is Rb(p), the contrast is expressed by the following equation (6).

[Math.6]

H_{b}(p,q,r)=D_{b}(p,q,r)/R_{b}(p) (6)

The roll-off characteristics can be adjusted to the second measuring beam.

[Math.7]

H_{b}(p,q,r)=D_{b}(p,q,r)/R_{b}(p)×R₂(p) (7)

In step A5, alignment of images of the measuring beam is performed. In other words, if the object to be examined is a moving object such as an eye, due to time difference in the measurement, the position of the image may be shifted. In other words, the first region to the third region in FIG. 5A are simultaneously scanned from the upper left of the figure in the x direction. At that time, the overlapping regions 508 and 509 may be misaligned due to the measuring beams although data of the same positions is required. In such a case, feature points of, for example, a blood vessel in the overlapping regions are matched.

In step A4, if normalization is performed according to equation (7), moving the image in the depth direction means that the contrast is changed according to the roll-off characteristics. Thus, the contrast adjustment can be performed after step A5. The apparatus is adjusted in advance so that misregistration does not occur when a subject that does not move is observed.

In step A6, a tomographic image is generated. According to the above-described signal processing, a 3D volume data can be obtained. Then, an image whose portions are naturally connected can be generated. Even if the image is cut at an arbitrary position on the line A-A′ cross section, the line B-B′ cross section, or the line C-C′ cross section, the portions are naturally connected.

In step A7, the measurement ends. If there is a different subject, the above-described steps are repeated.

If measurement data is available, a tomographic image can be obtained by simply adding signal processing to the measurement data.

According to the processing described above, by reducing the difference between images which is mainly due to characteristics of the spectrometer, a tomographic image whose connected portions are unnoticeable can be obtained.

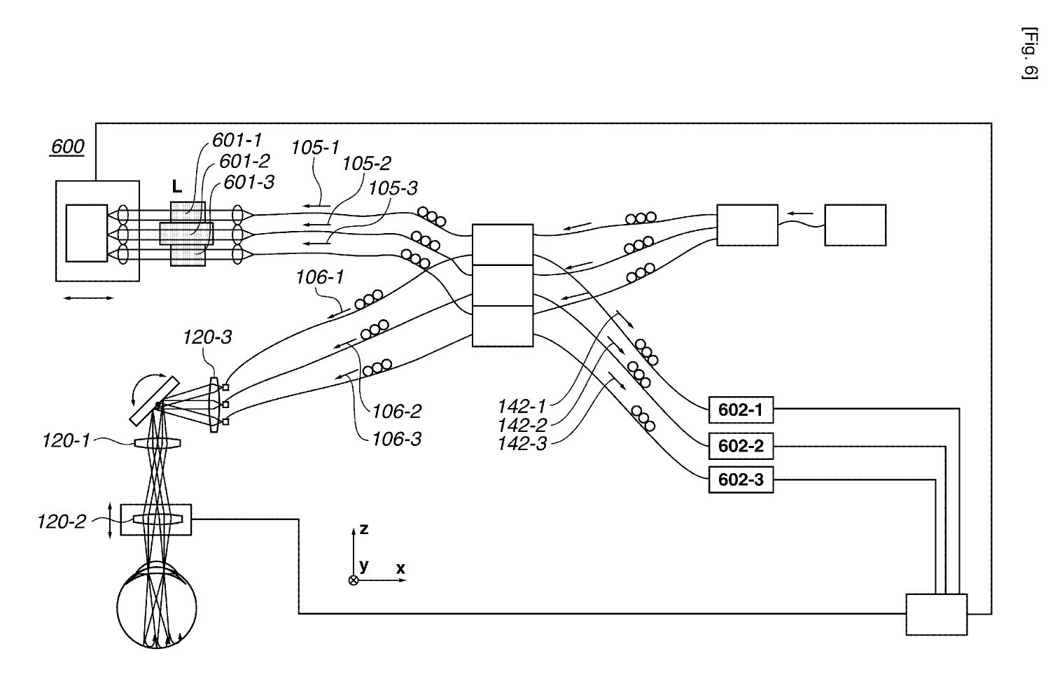

Next, a second exemplary embodiment of the present invention will be described. In the following description, the points different from the first exemplary embodiment are mainly described. As illustrated in FIG. 6, an OCT apparatus 600 according to the present embodiment constitutes a Michelson interferometer similar to the one described in the first exemplary embodiment. The points different from the first exemplary embodiment are that a dispersion compensation glass 601 includes portions having different thickness corresponding to each measuring beam and that three equivalent spectrometers are used for the measuring beams.

Now, a problem to be solved when wide angle view measurement is performed will be described. Regarding the measuring beam path, the positions where the measuring beams 106-1 to 106-3 pass through the lenses 120-1, 120-2, and 120-3 are different. This means that a problem related to lens aberration occurs. In order to address this problem, the positions of the dispersion compensation glass through which the reference beams 105-1 and 105-3 pass are thinner than the position of the dispersion compensation glass through which the reference beam 105-2 passes.

In other words, when wide angle view measurement is performed, if the dispersion compensation glass has a uniform thickness as is with the first exemplary embodiment, the reduction of resolution in the depth and horizontal directions occurs in the periphery of the lens. The reason is that although each measuring beam passes through a position of the glass having a different thickness by the scanning in a two-dimensional manner, the dispersion compensation glass is set so that it has a uniform thickness.

In the case of wide angle of view, the difference in the thickness of the glass in the periphery is especially increased. On the other hand, as is with the present embodiment, if the thickness of the dispersion compensation glass is changed, the connected portion of the image with respect to the boundary will be noticeable. Since equivalent spectrometers are provided on the detection optical path, problems of the connected portion related to the spectrometer are minimized.

Next, the influence of the dispersion will be described in detail. Regarding the envelope illustrated in FIG. 3 used in the description above, the plus side and the minus side are not symmetrical in a strict sense even if a measurement error is considered. This is due to the difference in the members used in the interferometer. The member is, for example, an optical coupler or a fiber. Thus, even if the optical system is simple, the system includes slight differences due to the members. Thus, if the thickness of the dispersion compensation glass in the reference beam path is changed and a measuring beam path corresponding to a wide angle of view is used as is in the second exemplary embodiment, not only a difference in the attenuation curve occurs but also a difference in the depth resolution can occur.

If the difference is caused by a difference in dispersion, then the dispersion can be compensated by signal processing. Although a great difference in dispersion needs a glass to correct it, if the difference is small, it can be corrected by signal processing. The signal processing is performed by using Hilbert transform being an analysis function.

In other words, if the spectrum of equation (1) is the real part and if the spectrum of equation (1) after Hilbert transform (HT) is the imaginary part, by using the imaginary unit i, the analysis function is obtained by the following equation (8).

[Math.8]

S(k)=\tilde{s}(k)+iHT(\tilde{s}(k))=|\tilde{s}(k)|exp(iφ) (8)

With respect to the phase component of equation (8), correction is performed with respect to the phase components of the secondary (a2) and the third (a3) in the following equation (9).

[Math.9]

φ(k)=φ₀(k)−a₂(k−k₀)²−a₃(k−k₀)³ (9)

k₀ denotes the center of the wave number and .phi.₀ denotes the initial phase. By replacing the real part of equation (8) after correction with a new spectrum, phase compensation can be performed by signal processing.

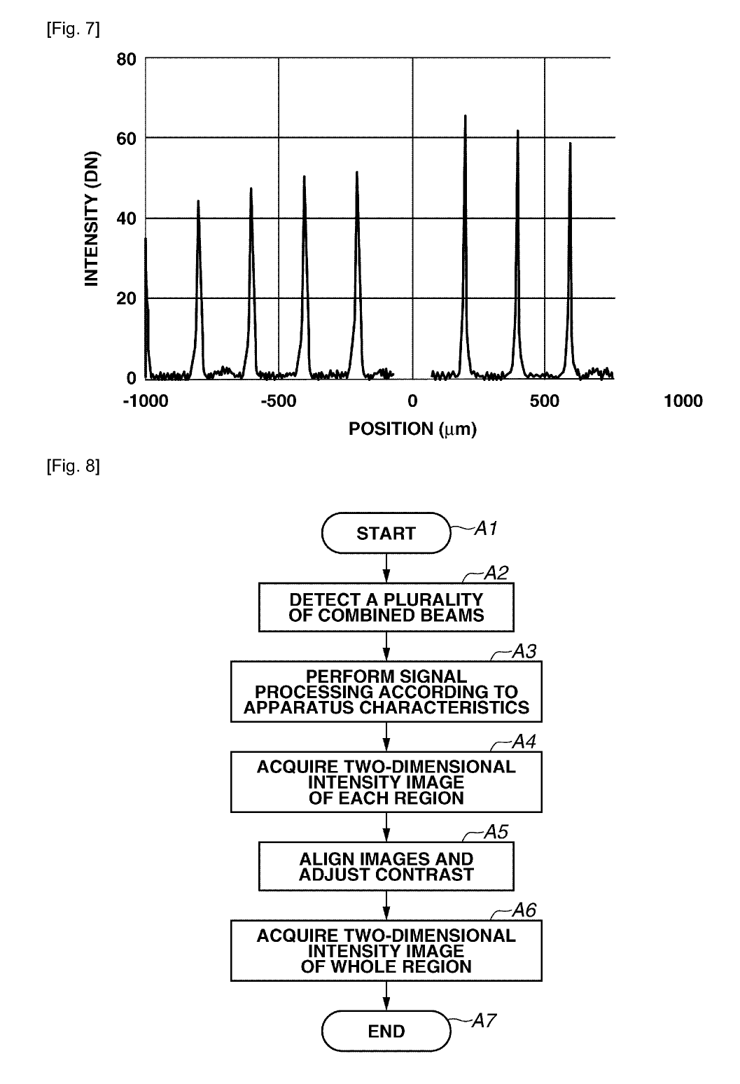

Next, a case where a glass with a thickness of 17 mm and a glass with a thickness of 18 mm are placed in each reference beam path and each measuring beam path of a simple optical system used in the experiment described above will be described. FIG. 7 illustrates a case where the parameters a2 and a3 of the dispersion compensation are determined so that the resolution on the plus side region is enhanced.

As can be seen, the attenuation greatly changes between the plus side and the minus side of the point of origin (coherence gate). Thus, the envelope is asymmetric with respect to the point of origin. Further, the depth resolution on the minus side is reduced compared to the depth resolution on the plus side. In other words, if the dispersion compensation is performed, the obtained dispersion does not always match the resolution expressed by equation (4).

Next, the signal processing used for correcting the dispersion compensation will be described. The signal processing according to the present embodiment is different from the processing in the first exemplary embodiment regarding processing in steps A3 and A4. These steps are replaced with steps A3′ and A4′ (not shown).

In step A1, the measurement is started. In step A2, the combined beams obtained by combining the three measuring beams and the three reference beams are detected by the line sensor 139. Then, the computer 125 acquires the detected data.

In step A3′, the computer 125 generates a tomographic image corresponding to each measuring beam based on the data obtained from the line sensor 139. The parameters of the dispersion compensation are adjusted so that the resolution at the boundary matches. In other words, by using the boundary regions 508 and 509, the parameters are adjusted so that the regions have the same resolution. In order to process errors due to hardware, the parameters are prepared in advance for each of the areas 506, 507, and 508. The parameters can be prepared for each B-scan image, or further, for each line.

In correcting dispersion due to influence of an object to be examined, the parameter is determined while comparing the images.

In step A4′, correction in the depth direction is performed. An envelope corresponding to the parameters of the dispersion compensation is prepared in advance. Processing expressed by equations (6) and (7) is performed according to the curve.

In step A5, the measuring beams are aligned. In step A6, a tomographic image is generated. In step A7, the measurement process ends.

According to the above-described processing, the difference between images mainly caused by the difference in dispersion can be reduced and a tomographic image whose connected portions are unnoticeable can be obtained.

An optical coherence tomographic imaging apparatus according to a third exemplary embodiment of the present invention emits a plurality of measuring beams onto an object to be examined via a measuring beam path. The return beam is guided to a detection position via the measuring beam path. The measuring beam is used for scanning an object to be examined by a scanner. The reference beam is guided to a detection position via a reference beam path. The return beam and the reference beam guided to the detection position are detected as a combined beam by a sensor. A mirror is located in the reference beam path. The position of the coherence gate can be adjusted by a stage. The processing of each unit can be performed by a computer functioning as a replacement apparatus and reading a computer program stored in a recording medium and performing the processing.

The third exemplary embodiment will now be described in detail with reference to drawings. The OCT apparatus of the present embodiment uses a plurality of measuring beams and is useful in making the difference in the connected portion caused by the difference in characteristics of the components of the spectrometer less noticeable.

The signal processing process according to the third exemplary embodiment will now be described with reference to FIGS. 8 and 1. In step A1, the measurement is started. Before the measurement is started, an OCT apparatus 200 is started and the subject's eye described below is set at a measurement position. Further, adjustment necessary in the measurement is performed by the operator.

In step A2, signals of a plurality of combined beams are acquired. Here, signals which are obtained by performing scanning with three measuring beams 106-1 to 106-3 via the XY scanner 119 are detected by the line sensor 139. The obtained data is acquired by the computer 125, which functions as first acquisition means. With respect to the coordinate system in FIG. 1, 512 lines are scanned in the x direction and 200 lines are scanned in the y direction. If the overlapping portions are excluded, 500 lines are scanned with the three measuring beams in the y direction.

The combined beams 142-1 to 142-3, which are derived from the three measuring beams, are incident on the line sensor 139, and one-dimensional A-scan data of 4096 pixels is acquired. Then, data of 512 successive lines in the x direction is stored in units of B-scan data in two-dimensional arrangement (4096×512, 12 bits). If the scanning ends, 200 pieces of the data will be stored for one measurement.

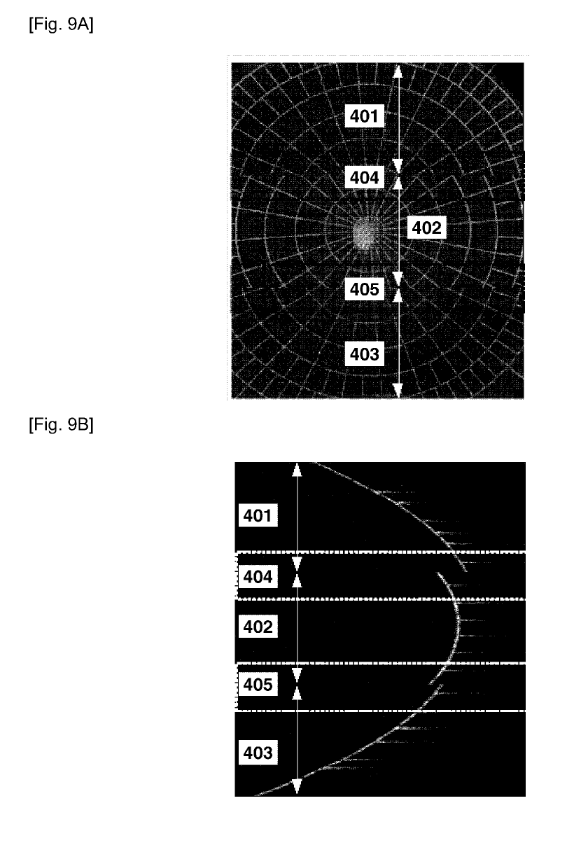

FIGS. 9A and 9B illustrate images of a schematic eye measured by using the method described above. FIGS. 9A and 9B illustrate images which are taken in a state where the adjustment of the position of the coherence gate used for correcting the difference in apparatus regarding fiber length is not performed. The schematic eye is a glass sphere having the optical characteristics, size, and capacity similar to those of a human eye. Concentric circles and radial patterns are formed on the fundus portion of the schematic eye. Further, the coherence gate is a position where the optical distance of the reference beam path is equal to the optical distance of the measuring beam path. By moving the position of the transmission diffraction grating 141, the position of the coherence gate can be adjusted.

FIG. 9A illustrates a two-dimensional intensity image. FIG. 9B illustrates a tomographic image of the first line that extends across the three measurement regions. A first region 401, a second region 402, and a third region 403, which are indicated by white arrows, are provided for the three measuring beams, respectively. Further, there are overlapping portions 404 and 405, which are enclosed by dotted lines, at the boundary of the areas.

In step A3, signal processing is performed according to the characteristics of the OCT apparatus 100 (tomographic imaging apparatus). As described above, the characteristics of the OCT apparatus 100 affect distribution characteristics of the combined beams detected by the line sensor 139. Thus, the computer 125 also functions as second acquisition means configured to acquire the distribution characteristics of the combined beams. Now, the two-dimensional intensity image (a cross-sectional image vertical with respect to the direction of emission of the measuring beam) will be described. In the case of an OCT apparatus, light intensity I_{det} detected by a spectrometer is expressed by the following equation (10), where the electric fields of the reference beam and the return beam are Er and Es, and the wave number is k.

[Math.10]

I_{det}(k)={Eᵣ(k)+Eₛ(k)}²=Iᵣ(k)+Iᵣₛ(k)+Iₛ(k) (10)

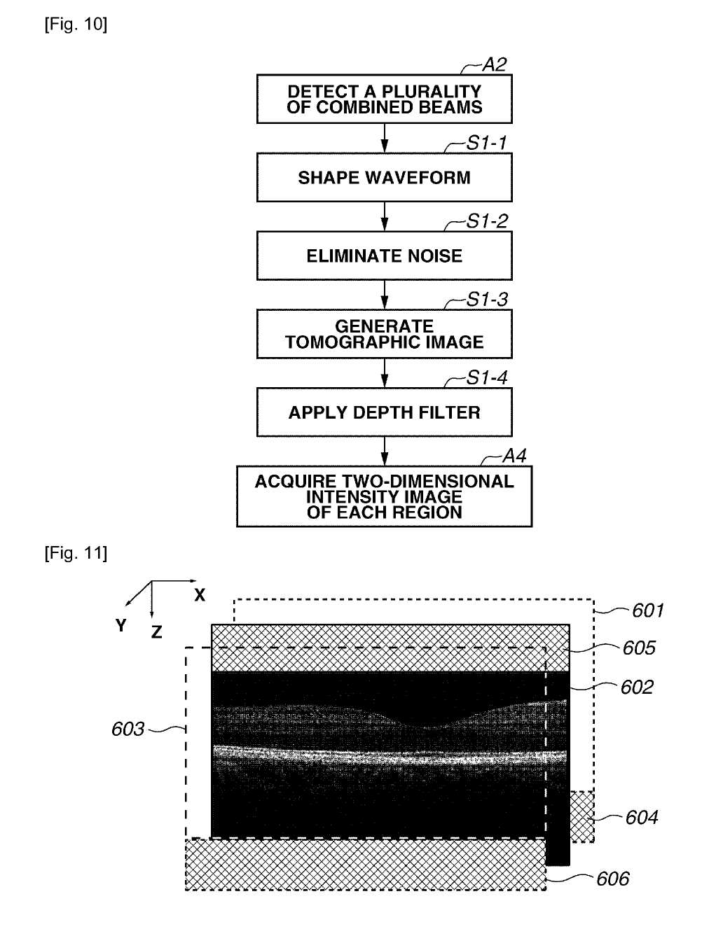

The first term on the right-hand side is an autocorrelation component of the reference beam, the second term is an interference component Iᵣₛ being a cross correlation of the reference beam and the return beam, and the third term is an autocorrelation component Iₛ of the return beam. Since a scanning laser ophthalmoscope (SLO) apparatus detects a return beam, the integration of the wave number of the third term corresponds to an SLO image. On the other hand, the OCT apparatus generates a tomographic image from the interference component in the second term. Further, since the third term is smaller than the first and the second terms, it is difficult to detect the third term by the OCT apparatus using a line sensor. However, by integrating the interference component of the second term, a two-dimensional intensity image corresponding to an SLO image can be generated. This signal processing will be described in detail with reference to FIG. 10.

In step S1-1, the waveform of each combined beam is extracted and shaped. First, zero elements are added to each A-scan data so that data of 2 to the n-th power, for example 2048, is obtained. In this manner, pixel resolution when the tomographic image is generated can be improved.

In step S1-2, noise elimination is performed. The noise elimination is performed by removing a fixed pattern included in a reference beam component and an interference component. A reference beam component acquired in advance can be used in the subtraction, or a mean value of wavelengths of the B-scan data can be used. Accordingly, the component of the second term of equation (10) can be extracted.

In step S1-3, a tomographic image is generated. Since the A-scan data of each measuring beam is data at regular intervals with respect to the wavelength, wavelength/wave number conversion is performed so that data with regular intervals with respect to the wave number is obtained. Next, the data is subjected to discrete Fourier transform so that intensity data with respect to the depth direction is obtained.

However, regarding this spectrometer, since the regions of the image formed on the line sensor by the detection light are different, the numerical values of the resolution in the depth direction and the attenuation characteristics (roll-off) in the depth direction for one pixel are different. Thus, by performing resampling in the z direction, the resolution in the depth direction is uniformed. The reference distance for one pixel is the resolution of the second measuring beam (the measuring beam having the measurement region at the center).

Further, the correction for uniforming the attenuation characteristics in the depth direction is performed. Before the correction is performed, the attenuation characteristics of all the measuring beams are measured or simulated in advance and stored. Then, the stored attenuation characteristics are converted into intensity of the measuring beam at the center. In performing the correction, the dispersion in the measurement path is considered as well as the difference due to the characteristics of the spectrometer.

In step S1-4, the depth filter is applied. In other words, since the resampling is performed in the z direction, the length of the B-scan image of each measuring beam is different. Thus, the images are extracted by a depth filter so the images have the same length. In this manner, a tomographic image is obtained. Further, the images are adjusted so that the differences in the dynamic ranges of the images due to noise or transmittance are removed in each measurement region. In other words, the images of the whole measurement regions are adjusted so that images at the same position of the B-scan tomographic image corresponding to the boundary portions 404 and 405 measured with different measuring beams become the same image. The tomographic image obtained in this manner has similar depth resolution and attenuation characteristics in the depth direction independent of the measuring beam.

In step A4, a two-dimensional intensity image of each region is obtained. By integrating the signals of the B-scan tomographic image obtained in step S3 for each line, a two-dimensional intensity image of 200×512 can be obtained for each region.

In steps A5 and A6, a two-dimensional intensity image of the whole region acquired by using the three measuring beams is obtained. In obtaining the two-dimensional intensity image of the whole region, the overlapping portions are excluded, and the positions of the images in the X and Y directions are aligned, and contrast adjustment is performed as needed.

Then, the measurement of the subject's eye is performed by using the OCT apparatus, which performs signal processing according to the characteristics of the apparatus.

As described above, even if different measuring beams are used, by arranging the tomographic images at the same position in the boundary region to be the same, the difference between the images mainly due to characteristics of the spectrometer can be reduced and a two-dimensional intensity image whose connected portions are unnoticeable can be obtained.

Data of a three-dimensional tomographic image which has undergone the signal processing corresponding to the characteristics of the apparatus is generated, and an image whose connected portions on the XZ plane and on the XY plane are unnoticeable can be obtained.

Next, a fourth exemplary embodiment of the present invention will be described. Here, the difference from the third exemplary embodiment is mainly described. According to the present embodiment, the measurement is performed using each measuring beam after changing the position of the coherence gate. In other words, regarding the OCT measurement, due to attenuation characteristics, signal strength increases as the coherence gate becomes closer to the measurement position of an object to be examined. Thus, in measuring a fundus which is curved or is at an angle, it is convenient to position the coherence gate of each measuring beam at the optimum position. As a result, when a two-dimensional intensity image is generated, the difference between the regions becomes noticeable. Although an example using a schematic eye is described in the third exemplary embodiment, the subject's eye is actually measured in the present embodiment.

The difference between the apparatus configurations is that the reference minor 114 set in the motorized stage 117 can be independently controlled with respect to each measuring beam. Thus, each position of the coherence gate can be independently adjusted.

Next, the signal processing process will be described with reference to FIGS. 8 and 10. The difference from the third exemplary embodiment will be described.

In step A2, a plurality of combined beams are acquired. First, the depth position is set for each measurement region. Before determining the setting method, tomographic images in the vertical and horizontal directions are acquired at the time of alignment or the like. Then, the setting method is determined based on the acquired information. Since a general alignment method is used, the description of the alignment method is omitted. After then, the measurement of each region is performed. The following description is on the assumption that the coherence gate of the first region is set at the same position as the coherence gate of the third region, and the position of the coherence gate of the second region is set closer to the retina compared to the coherence gates of the other regions.

In step A3, signal processing according to the apparatus characteristics is performed. Here, a case where the positions of the coherence gates are different with respect to each measuring beam is described.

In step S1-1, the waveform shaping is performed. In step S1-2, the noise elimination is performed.

In step S1-3, a tomographic image is generated. First, with respect to A-scan data of each measuring beam, wavelength/wave number conversion is performed, and then discrete Fourier transform is performed. Accordingly, intensity data with respect to the depth is obtained. Since an equivalent spectrometer is used for each measurement region, the depth resolution and the attenuation characteristics from the coherence gate of the measurement regions are regarded as equal. However, since the positions of the coherence gate are different, the image is generated according to the position of the coherence gate of an image which has the farthest coherence gate. The position of the coherence gate can be determined according to the position of the reference minor 114.

FIG. 11 schematically illustrates a relative positional relation of the B-scan tomographic images of the respective regions. The B-scan images of the respective measuring beams are a first tomographic image 601 indicated by a dotted line, a second tomographic image 602 indicated by a solid line, and a third tomographic image 603 indicated by a broken line. The positions of the coherence gates of the first tomographic image and the third tomographic image are distant from the object to be examined compared to the position of the coherence gate of the second tomographic image. As a result, first additional data 604 and third additional data 606 are added to deep positions.

On the other hand, second additional data 605 is added to a shallower position. The data to be added is, for example, a mean noise level or zero. In this manner, the ranges of all the regions in the depth direction match. Then, the attenuation characteristics in the depth direction are corrected so that the same characteristics are obtained for each region. As a result, the contrast of the same layer becomes seamless.

In step S1-4, the depth filter is applied. However, since the adjustment is performed so that all regions have the same number of pixels, this processing is not necessary unless a specific layer is to be extracted.

In step A4, a two-dimensional intensity image of each region is obtained. By integrating the signal of the B-scan tomographic image obtained in step S3 for each line, a two-dimensional intensity image of 200×512 is obtained for each region.

In steps A5 and A6, a two-dimensional intensity image of the whole region acquired by using the three measuring beams is obtained. In obtaining the two-dimensional intensity image of the whole region, the overlapping regions are excluded and positions of the images in the X and Y directions are matched.

According to the above-described processing, a difference in two-dimensional intensity images due to the positions of the coherence gates is reduced and a two-dimensional intensity image whose connected portion is unnoticeable can be generated. Further, data of a three-dimensional tomographic image is generated, and an image whose connected portions on the XZ plane and the XY plane are unnoticeable can be obtained.

A fifth exemplary embodiment of the present invention will be described. In the following description, the difference from the third exemplary embodiment will be mainly described. The present embodiment is different from the third exemplary embodiment in that a light source is prepared for each measurement region. In some cases, the light quantity of the SLD light source is not sufficient. In such a case, it is not possible to split light from one light source and simultaneously direct beams onto a plurality of measurement regions. On the other hand, if a plurality of light sources are used, even if the light sources are of the same manufacturer, characteristics such as a spectrum shape or a wavelength band may be different. As a result, a difference arises in two-dimensional intensity images of the respective regions.

The differences between the apparatuses are that three different light sources are used for the light source 101 and that three spectrometers, which are independent and equivalent, are used.

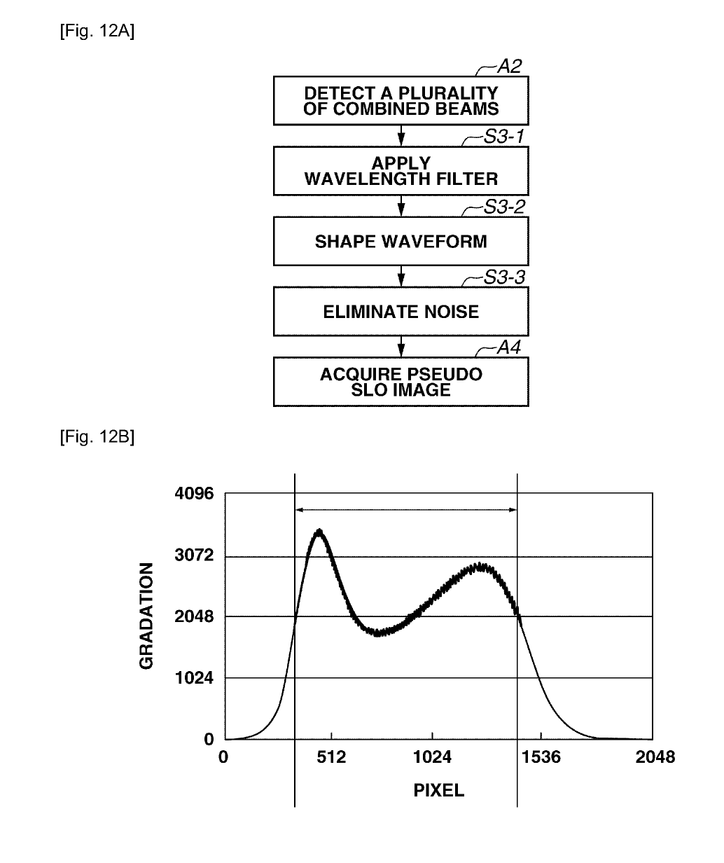

Next, a difference in the signal processing process will be described. FIG. 12A illustrates the signal processing steps in step A3 in FIG. 8. Here, a case where the wavelength spectrum and the band are different will be described.

In step S3-1, a wavelength filter is applied to the signals obtained in step A2. FIG. 12B illustrates a wavelength spectrum. The filtering is adjusted so that the same wavelength band is obtained from each measuring beam. The filtering of the same band is determined by directing each measuring beam onto each spectrometer and comparing the obtained data. Here, the filtering position of the spectrometer is set so that the wavelength matches the light source of the second region.

In step S3-2, waveform shaping is performed. If each light source spectrum has a different shape, correction is performed so that the spectrum of each reference beam is the same as the spectrum of the center measuring beam. The method, however, is not limited to such a correction, and normalization being dividing each measuring beam by each reference beam can also be performed.

In step S3-3, the noise elimination is performed. This step is to extract an interfering beam component in equation (10).

In step A4, a two-dimensional intensity image of each region is obtained. Here, a root mean square of the spectrum of the interfering beam component obtained in step S3-3 for each pixel is integrated for each line. As a result, a two-dimensional intensity image (200×512) for each region is obtained.

In steps A5 and A6, a two-dimensional intensity image of the whole region acquired from three measuring beams is obtained. In this step, the overlapping regions are excluded and each image is aligned in the X and Y directions. Further, each measurement region is adjusted so that the dynamic ranges, which are dependent on noise or transmittance, of the images are equal, and then the two-dimensional intensity image of the whole region is obtained.

As described above, even if the measuring beams are emitted from different light sources, the difference between the measurement regions is reduced and a two-dimensional intensity image whose connected portion is unnoticeable can be obtained.

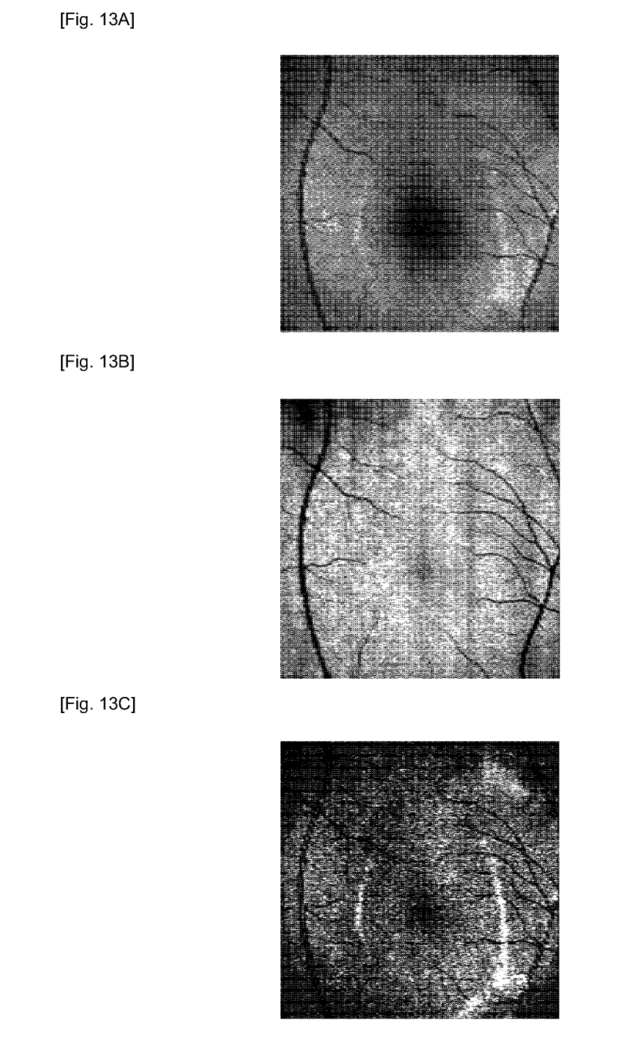

FIGS. 13A, 13B, and 13C illustrate two-dimensional intensity images of a fundus captured by using one measuring beam. The images have undergone different processing. FIG. 13A is a case where no filter is used. FIG. 13B is a case where a depth filter is used. FIG. 13C is a case where a wavelength filter is used. By actively narrowing the range of the depth filter, a structure of a layer in a specified region can be extracted. Further, by using a wavelength filter, a specific wavelength can be enhanced.

For example, by selecting a wavelength that reacts with a contrast agent or a marker, its position can be made recognizable. In this manner, a great amount of information can be obtained by using a two-dimensional intensity image corresponding to a specific depth region, a two-dimensional intensity image corresponding to a specific wavelength, and, further, a tomographic image. In displaying the images on a screen, all the images can be displayed at a time or the display of the images can be switched.

As described above, according to the present embodiment, even if a light source corresponding to each measuring beam is individually used, a two-dimensional intensity image whose connected portion is unnoticeable can be generated.

Further, when imaging is performed by using a contrast agent or a marker, by selecting a wavelength that matches the contrast agent or the marker, an image which can be used in confirming a state of the position of a portion which the contrast agent aims at can be obtained. According to the above-described exemplary embodiments, processing of a cross-sectional image (two-dimensional intensity image), which is vertical to the measuring beam, is described. However, the above-described processing can also be applied to a cross-sectional image taken from an angle different from the vertical direction to the measuring beam.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-082809 filed Mar. 31, 2010 and No. 2010-082812 filed Mar. 31, 2010, which are hereby incorporated by reference herein in their entirety.

1. A tomographic imaging apparatus configured to acquire a tomographic image or a cross-sectional image of an object to be examined from signals of a plurality of interfering beams obtained by emitting a plurality of measuring beams to the object to be examined and causing return beams of the measuring beams to interfere with reference beams, the tomographic imaging apparatus comprising:
a sensor configured to detect the plurality of interfering beams to acquire signals of the plurality of interfering beams for measuring the object at several locations;
acquisition means configured to acquire optical characteristics of the tomographic imaging apparatus for each of the plurality of interfering beams, wherein each of the optical characteristics has an influence on distribution of each of the plurality of interfering beams on the sensor; and
generation means configured to generate a tomographic image or a cross-sectional image of the object to be examined by combining processing based on the signals of the plurality of interfering beams and correcting processing based on the optical characteristics.

2. The tomographic imaging apparatus according to claim 1, wherein the generation means corrects the signals of the plurality of interfering beams based on the optical characteristic, and generates a plurality of tomographic images of the object to be examined from the corrected signals of the plurality of interfering beams, and wherein the tomographic imaging apparatus further comprises combining means configured to perform alignment of the plurality of tomographic images and to combine the aligned plurality of tomographic images.

3. (canceled)

4. The tomographic imaging apparatus according to claim 1, wherein the optical characteristic is a characteristic based on at least one of a configuration of an optical system for dispersion compensation and a configuration of a diffraction grating for diffracting the plurality of interfering beams in the tomographic imaging apparatus.

5. The tomographic imaging apparatus according to claim 1, wherein each of the signals of the plurality of interfering beams expresses a cross section of the object to be examined that is parallel to an emission direction of the plurality of measuring beams.

6. The tomographic imaging apparatus according to claim 1, wherein the cross-sectional image is a cross-sectional image of a plane perpendicular to an emission direction of the plurality of measuring beams.

7. The tomographic imaging apparatus according to claim 6, wherein the generation means generates a cross-sectional image of a plane perpendicular to the emission direction of the plurality of measuring beams based on a wavelength spectrum.

8. A control apparatus for a tomographic imaging apparatus configured to acquire a tomographic image or a cross-sectional image of an object to be examined from signals of a plurality of interfering beams obtained by emitting a plurality of measuring beams to the object to be examined and causing return beams of the measuring beams to interfere with reference beams, the control apparatus comprising:
first acquisition means configured to detect the plurality of interfering beams to acquire signals of the plurality of interfering beams for measuring the object at several locations;
second acquisition means configured to acquire optical characteristics of the tomographic imaging apparatus for each of the plurality of interfering beams, wherein each of the optical characteristics has an influence on distribution of each of the plurality of interfering beams on the sensor; and
generation means configured to generate a tomographic image or a cross-sectional image of the object to be examined by combining processing based on the signals of the plurality of interfering beams and correcting processing based on the optical characteristics.

9. A computer program for causing a computer to function as a control apparatus for a tomographic imaging apparatus configured to acquire a tomographic image or a cross-sectional image of an object to be examined from signals of a plurality of interfering beams obtained by emitting a plurality of measuring beams to the object to be examined and causing return beams of the measuring beams to interfere with reference beams, the control apparatus comprising:
first acquisition means configured to detect the plurality of interfering beams to acquire signals of the plurality of interfering beams for measuring the object at several locations;
second acquisition means configured to acquire optical characteristics of the tomographic imaging apparatus for each of the plurality of interfering beams, wherein each of the optical characteristics has an influence on distribution of each of the plurality of interfering beams on the sensor; and
generation means configured to generate a tomographic image or a cross-sectional image of the object to be examined by combining processing based on the signals of the plurality of interfering beams and correcting processing based on the optical characteristics.
